(19) United States
(12) Patent Application Publication
(10) Pub. No.: US 2026/0120500 A1
(43) Pub. Date: Apr. 30, 2026

(54) SYSTEM AND METHOD FOR WEBSITE ANALYSIS USING COMPUTER VISION

(71) Applicant: Securiport LLC, Reston, VA (US)

(72) Inventors: Roberto Leandro OLIE, Reston, VA (US); Nathan CARPENTER, Reston, VA (US); Felipe SEGURA, Reston, VA (US); Enrique SEGURA, Reston, VA (US)

(21) Appl. No.: 19/374,113

(22) Filed: Oct. 30, 2025

Related U.S. Application Data
(60) Provisional application No. 63/714,085, filed on Oct. 30, 2024.

(51) Int. Cl. G06V 30/416; G06F 40/30; G06V 10/25; G06V 10/26; G06V 10/764; G06V 10/774; G06V 10/776; G06V 10/82; G06V 20/70; G06V 30/148; G06V 30/19; G06V 30/413

(52) U.S. Cl. CPC G06V 30/416; G06F 40/30; G06V 10/25; G06V 10/26; G06V 10/764; G06V 10/774; G06V 10/776; G06V 10/82; G06V 20/70; G06V 30/148; G06V 30/19147; G06V 30/19173; G06V 30/413

(57) ABSTRACT

A system and method for website analysis using computer vision processes rendered webpages as visual documents rather than parsing code structures. The system renders target webpages in browser environments to generate pixel-based visual representations, applies computer vision models trained specifically on webpage layout patterns to segment the representations into distinct content regions, classifies regions based on visual characteristics and semantic analysis, and synthesizes structured output artifacts. The approach maintains extraction consistency despite changes in underlying website markup structures, reducing maintenance requirements compared to traditional DOM-based scraping methods. The system supports applications including accessibility enhancement, content moderation, competitive intelligence, digital archiving, and news aggregation while respecting legal and ethical boundaries.

### PRIORITY INFORMATION

This application claims the benefit of the U.S. Provisional Patent Application No. 63/714,085 filed on Oct. 30, 2024, which is hereby incorporated by reference in its entirety.

### FIELD OF THE INVENTION

The embodiments of the present disclosure generally relate to systems, devices, methods, and computer-readable instructions for analyzing website content through computer vision and natural language processing, particularly relating to visual analysis of rendered webpages using computer vision models to extract structured data independent of website markup languages and underlying technical implementation.

### BACKGROUND

Web scraping, the automated extraction of data from websites, faces significant challenges across different website architectures. Static websites, which deliver pre-rendered HTML content, are relatively straightforward to scrape because data is embedded directly in the source code. Dynamic websites, however, generate content using client-side technologies such as JavaScript, loading data after the initial page delivery. Single-page applications (SPAs) compound these difficulties by updating content dynamically without full page reloads, requiring scrapers to execute JavaScript and monitor Document Object Model (DOM) changes in real-time. These technical complexities are further exacerbated by anti-scraping countermeasures including rate limiting, CAPTCHAs, IP blocking, and behavioral analysis systems designed to detect and prevent automated access.

Existing web scraping technologies rely primarily on parsing the Document Object Model (DOM) or executing JavaScript to access dynamically loaded content. These approaches share common limitations: they require detailed knowledge of each website's specific structure and naming conventions, necessitate frequent updates as websites evolve, and lack semantic understanding of content relevance. Traditional scrapers extract data by targeting specific HTML elements, CSS selectors, or API endpoints-methods that become obsolete when websites redesign their architecture or obfuscate their code. Even sophisticated scrapers using headless browsers to render JavaScript must continuously adapt their selectors and navigation logic to accommodate structural changes. Furthermore, these approaches typically extract predefined data types without comprehending the webpage as a cohesive visual and semantic entity, limiting their ability to distinguish meaningful content from navigational elements, advertisements, or decorative features.

As an illustrative example of the structural fragility problem, on amazon.com, the current path to the element containing an item's new price (known as a “selector”) is: #corePrice feature_div>div>div>div>div>span.a-price.a-text-normal.aok-align-center.reinventPriceAccordionT2>span: nth-child (2). However, this structure is completely within the control of Amazon and can change at any time without notice, rendering pre-programmed scrapers non-functional until manually updated. This maintenance burden multiplies when scraping hundreds or thousands of different websites, each with unique and frequently changing structures.

Multi-page applications (MPAs), where servers deliver relatively static HTML structures, present a more stable scraping environment because content organization remains consistent across requests. Scrapers designed for MPAs excel at extracting structured data from e-commerce sites, review platforms, and databases where data fields follow predictable patterns. However, even these systems require manual reconfiguration when websites update their layouts or element identifiers. The fundamental limitation across all code-based scraping methodologies is their dependence on understanding and interfacing with the underlying technical implementation rather than interpreting the content as a human user would—by visual appearance and semantic context.

Single-page applications (SPAs), which rely on JavaScript execution to render website content dynamically, introduce additional challenges. For SPAs (such as Gmail, Facebook, or modern web applications built with React, Angular, or Vue.js), the initial page delivered to the browser contains minimal content-primarily a JavaScript program that executes to generate the visible content. Scraping SPAs requires the scraper to mimic browser behavior in executing scripts and reacting dynamically to structural and data changes, making this approach complex, resource-intensive, and impractical for large-scale operations, especially in light of evolving web standards and stricter anti-bot provisions.

Various prior art technologies exist in the web scraping and computer vision domains. Headless browser technologies such as Selenium, Puppeteer, and Playwright enable automated webpage rendering and interaction, but these tools remain dependent on DOM manipulation and structural understanding of target websites. Optical character recognition (OCR) technologies, including Tesseract and commercial solutions, can extract text from images but lack the layout understanding and semantic classification necessary to distinguish relevant content from peripheral elements. Document analysis systems using computer vision have been developed for processing scanned documents and PDFs, but these are optimized for standardized document formats rather than the diverse and dynamic layouts encountered in modern web design.

The present invention distinguishes from these existing approaches in several key aspects. While headless browser technologies can render webpages and extract content through DOM manipulation, these tools remain vulnerable to structural changes in website code. While OCR technologies can extract text from images, they lack semantic understanding of content hierarchy and relevance. While document analysis systems can segment and classify visual content, they are not adapted to the specific design conventions, layout patterns, and content types characteristic of modern websites. The present invention combines computer vision for layout understanding, OCR for text extraction, natural language processing for semantic classification, and webpage-specific training to create a holistic system that mimics human visual comprehension of webpages while maintaining robustness against structural and technological changes.

### SUMMARY OF THE INVENTION

Accordingly, the embodiments of the present disclosure are directed to systems, devices, methods, and computer-readable instructions for website analysis using computer vision that substantially obviate one or more problems due to limitations and disadvantages of the related art.

The disclosed technology addresses a fundamental technical problem in web scraping: the fragility of code-based extraction methods when confronted with website structural changes, dynamic content generation, and diverse technical implementations. Rather than parsing HTML structure or executing JavaScript to access the DOM, the invention processes rendered webpages as visual documents, applying computer vision models specifically trained to recognize webpage layout patterns, content hierarchies, and design conventions that remain consistent even when underlying code changes substantially.

In various embodiments, the system employs computer vision techniques in combination with natural language processing to extract and transform website content into formats suitable for both automated analysis and human understanding. The system renders target webpages as pixel-based visual representations, segments these representations using convolutional neural networks adapted for webpage-specific patterns, classifies content regions based on visual and semantic characteristics, and synthesizes structured outputs that preserve relevant information while filtering peripheral elements.

The disclosed approach represents an unconventional application of computer vision technologies. Traditional computer vision applications focus on natural scene understanding, facial recognition, or industrial inspection where visual patterns are consistent and physical. In contrast, the present invention adapts computer vision to analyze synthetic graphical content (rendered webpages) where visual patterns follow human design conventions rather than physical laws. This unconventional application required developing specialized training methodologies, feature extractors sensitive to typography and layout geometry, and integration of visual analysis with textual semantic understanding through natural language processing-a combination not found in conventional computer vision applications.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, methods for website analysis using computer vision include: retrieving a designated webpage from a network location; rendering the webpage in a browser environment to generate pixel-based visual representations; applying computer vision models trained on webpage layout patterns to segment the visual representations into distinct content regions based on spatial positioning, color contrast, and typographic characteristics; classifying segmented regions into predetermined categories using visual features combined with optical character recognition results; extracting structured data from regions classified as primary content while excluding regions classified as navigation or advertisement; and generating output artifacts that maintain extraction consistency even when the target webpage's underlying markup structure changes while visual presentation remains substantially similar.

The systems for implementing these methods include: a rendering engine configured to generate visual representations of webpages independent of underlying markup language; a segmentation processor employing convolutional neural networks with architectures adapted specifically for webpage layout analysis rather than natural image processing; a classification module configured to categorize content regions based on visual characteristics, positional relationships, and semantic analysis of extracted text; and a synthesis processor configured to generate structured artifacts in multiple formats including static webpages, plain text documents, and annotated datasets suitable for machine learning applications.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a system architecture for a web data extraction and analysis platform according to an example embodiment.

FIG. 2 illustrates a flowchart for the method utilized by the system architecture depicted in FIG. 1 according to an example embodiment.

### DETAILED DESCRIPTION OF THE EXEMPLARY EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

Terms used in example embodiments are selected from currently widely used general terms when possible while considering the functions in the present disclosure. However, the terms may vary depending on the intention of a person skilled in the art, precedents, the emergence of new technology, and the like. Further, in certain cases, there are also terms arbitrarily selected by the applicant, and in these cases, the meaning will be described in detail in the corresponding descriptions. Therefore, the terms used in the present disclosure should be defined based on the meanings of the terms and the overall content of the present disclosure rather than simple names of the terms.

User interfaces and devices for viewing websites that may include a plurality of webpages are described. In some embodiments, the device is a portable communication device (e.g., a mobile phone or tablet computer). The user interfaces may be applied to other devices, such as personal computers and laptop computers. The system components described herein can be implemented using one or more processors, memory systems, storage devices, and communication interfaces operating in conjunction to perform the disclosed functions.

As discussed in the background section, existing web scraping technologies face significant limitations. The inventors have identified that the fundamental issue is not merely the technical diversity of websites (static HTML, JavaScript-heavy SPAs, various frameworks), but rather the architectural assumption underlying current scraping approaches: that content must be accessed through its code representation. This assumption creates inherent fragility because code structures are implementation details subject to frequent, unpredictable changes, while the visual presentation of content follows more stable human-centered design conventions.

The inventors have developed a system that analyzes websites through visual interpretation rather than code parsing, mimicking human perception to identify and extract relevant content independent of the underlying technical implementation. This approach leverages the observation that websites, despite vast technical diversity, converge on common visual patterns because they are designed for human visual consumption. Headers appear at the top with larger fonts, navigation elements cluster in predictable locations, primary content occupies central regions with consistent typography, and advertisements display in visually distinct boundary boxes. These visual conventions persist across technical implementations because they serve fundamental human cognitive needs.

The disclosed system employs computer vision to process rendered webpages as visual artifacts. Specifically, the system uses object detection models to identify content regions based on visual boundaries, color contrast, and spatial relationships; optical character recognition to extract text while preserving font characteristics and formatting; and layout analysis to understand hierarchical relationships between page elements based on positioning, sizing, and visual grouping principles. By combining computer vision with natural language processing, the system evaluates content relevance based on semantic meaning rather than structural position in the DOM, enabling filtering of navigational clutter, advertisements, and boilerplate text while preserving substantive information.

The computer vision models employed by the disclosed system are specifically adapted for webpage analysis rather than natural image processing. Unlike conventional object detection models trained on datasets such as ImageNet or COCO, which contain photographs of physical objects in natural settings, the disclosed system utilizes models trained on a diverse corpus of rendered webpage screenshots. The training dataset comprises manually annotated webpages representing various industries (e-commerce, news, social media, corporate, governmental), design eras (from early 2000s table-based layouts to modern responsive designs), technical implementations (static HTML, jQuery-based sites, React/Angular/Vue.js applications), and cultural contexts (diverse languages, reading directions, and design aesthetics).

The segmentation processor employs a modified region-based convolutional neural network architecture, such as Mask R-CNN or a custom variant optimized for document layout analysis. The model architecture includes several adaptations for webpage-specific processing: (1) the region proposal network generates candidate bounding boxes at aspect ratios and scales optimized for common webpage dimensions and element types (wide horizontal boxes for navigation bars, narrow vertical boxes for sidebars, large rectangular regions for content areas) rather than natural object proportions; (2) the feature extraction layers use convolutional filters tuned to detect webpage-specific visual patterns including text blocks, button elements, form fields, image galleries, and video players; (3) the classification head categorizes regions into webpage-specific classes such as header, navigation, primary content, sidebar, advertisement, footer, modal overlay, and cookie notice rather than natural object categories.

Training methodology involves supervised learning on annotated webpage datasets. Each training sample comprises a rendered webpage screenshot paired with pixel-level segmentation masks indicating content region boundaries and category labels. The training process optimizes model parameters to minimize segmentation error and classification error simultaneously, using loss functions weighted to prioritize accurate identification of primary content regions over peripheral elements. Data augmentation techniques include: varying viewport sizes to simulate different screen resolutions and device types; applying color adjustments to handle different design palettes and color schemes; introducing synthetic occlusions to simulate popup windows and overlays; and simulating different zoom levels to handle responsive design variations.

The system supports continuous model improvement through active learning. When the content processor identifies low-confidence classifications (based on softmax probability thresholds) or when synthesis processor generates artifacts flagged by quality assurance processes, these instances may be queued for human review. After expert annotation, these examples are incorporated into the training corpus, and the model undergoes incremental retraining or fine-tuning. This feedback loop enables the system to adapt to emerging design trends, novel webpage layouts, and previously unencountered content types without requiring manual reconfiguration of extraction rules or selectors.

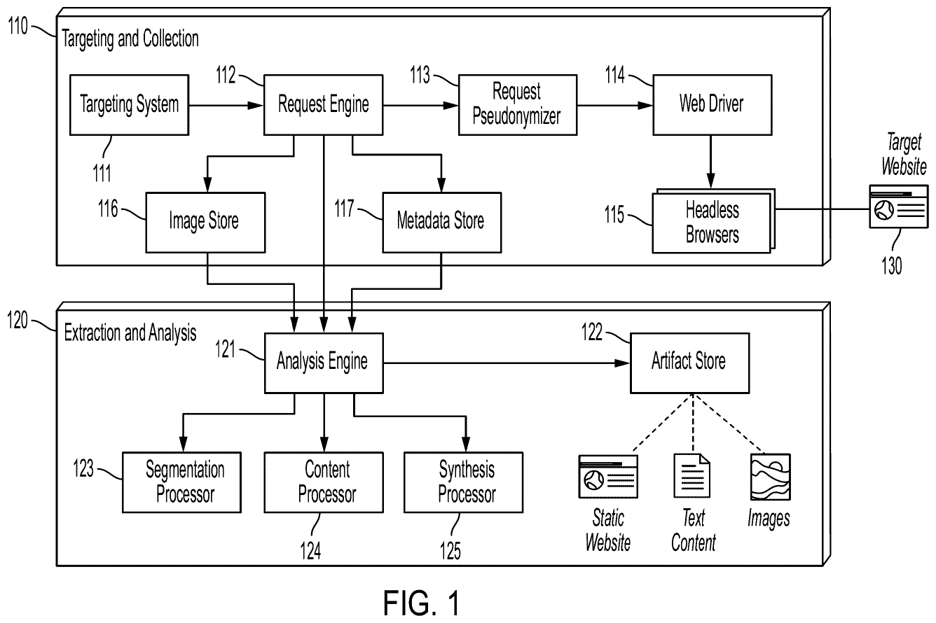

FIG. 1 illustrates a system architecture for a web data extraction and analysis platform according to an example embodiment. The system comprises two primary functional sections: Targeting and Collection 110, and Extraction and Analysis 120. The components of the system architecture can be implemented by one or more computer systems. Although multiple processing functions are shown, the processing functions can be executed by a single processor or distributed across multiple processors. Similarly, although storage functions are depicted as separate components, they may be implemented using a unified storage system or distributed across multiple storage devices. The system components may execute on a single computing device, across multiple networked devices, or in a cloud computing environment with distributed processing and storage resources.

In the Targeting and Collection 110 section, the targeting system 111 provides a user interface and supporting software to allow users to maintain a set of target websites and request parameter definitions. The targeting system 111 stores information identifying target webpages (such as URLs, REST endpoints with payloads, or database queries that return URLs), scheduling parameters (execution frequency, time windows, priority levels), and configuration options (viewport dimensions, user agent strings, authentication credentials). The request engine 112 accesses information from the targeting system 111, determines when and how to execute requests based on scheduling parameters, and coordinates the overall data collection workflow.

The request engine 112 communicates with a request pseudonymizer 113 to modify request parameters according to defined policies. The request pseudonymizer 113 may alter IP addresses through proxy rotation, modify HTTP headers (user agent strings, referrer information, accept-language preferences), adjust request timing to mimic human browsing patterns, or transform payload data to protect sensitive information (redacting personally identifiable information, masking financial data, replacing proprietary identifiers). The purpose of request pseudonymization is to distribute access load across network endpoints, avoid triggering rate limits, and protect user privacy when processing sensitive data, while maintaining compliance with website terms of service and applicable legal requirements including robots.txt directives.

The web driver 114 receives requests from the request pseudonymizer 113 and submits them to one or more headless browsers 115. Headless browsers are browser engines (such as Chromium, Firefox, or WebKit) that render webpages without displaying a graphical interface, enabling automated operation. The headless browsers 115 execute requests against target websites 130, rendering HTML content, executing JavaScript code, applying CSS styling, loading external resources, and generating the final visual presentation of the webpage. The web driver 114 captures the rendered output as one or more images (screenshots of the viewport at various scroll positions to capture content extending beyond a single screen), along with metadata including HTTP response codes and headers, page load timing information, console messages and errors, network request logs, and the raw HTML source code.

The request engine 112 stores the captured images in an image store 116 and the associated metadata in a metadata store 117. The image store 116 may comprise a file system, object storage service, or specialized image database optimized for storing and retrieving large numbers of screenshots. The metadata store 117 may comprise a relational database, document database, or key-value store indexed for efficient querying by target identifier, capture timestamp, or other relevant attributes. After storing the data, the request engine 112 triggers the analysis engine 121 to begin processing the captured webpage data.

The Extraction and Analysis 120 section comprises an analysis engine 121, which coordinates the processing workflow, and specialized processors for segmentation, classification, and synthesis. The analysis engine 121 receives notifications from the request engine 112 identifying newly captured webpage data, retrieves the corresponding images from image store 116 and metadata from metadata store 117, and orchestrates the multi-stage analysis process.

The segmentation processor 123 receives rendered webpage images from the analysis engine 121 and applies computer vision models to deconstruct the images into normalized representations of visual elements. The segmentation process identifies visually distinct regions such as: header sections typically located at the top of the page with distinctive styling; navigation menus presented as horizontal bars, vertical sidebars, or hamburger-style collapsible menus; primary content areas containing article text, product descriptions, or main page information; secondary content including sidebars, related items, and supplementary information; advertisement regions often identified by distinct boundary styling, positioning in peripheral page areas, or characteristic dimensions; footer sections containing copyright notices, site maps, and contact information; and interactive elements such as buttons, form fields, and media players.

The segmentation processor 123 preserves original positional context during segmentation, maintaining absolute pixel coordinates for each identified region. This positional information enables accurate reconstruction of the original layout when generating certain types of output artifacts. Each segmented region is associated with a confidence score indicating the model's certainty in its classification, bounding box coordinates defining the region's position and dimensions, visual features extracted during processing (dominant colors, text density, presence of images or interactive elements), and relationships to neighboring regions (hierarchical parent-child relationships, sequential reading order).

The content processor 124 receives the segmented regions from the analysis engine 121 and performs detailed analysis of each region based on its type. For text-containing regions, the content processor applies: language identification to determine the character set and language using statistical analysis or neural language models; optical character recognition (OCR) to extract text content while preserving formatting information such as font sizes, styles, and colors; text classification to categorize content as article text, product descriptions, user reviews, news headlines, or other content types; and named entity recognition to identify persons, organizations, locations, dates, and other entities within the text.

For image-containing regions, the content processor applies: image classification to identify the type of image (photograph, diagram, icon, logo, infographic); object detection within images to identify depicted objects, people, or scenes; facial recognition when appropriate and permitted by applicable regulations; optical character recognition for text embedded in images; and inappropriate content detection using specialized models trained to identify categories such as violence, explicit content, or child sexual abuse material (CSAM), which may utilize services such as Safer.io or proprietary classifiers, with positive identifications triggering special handling procedures including content blurring, textual description generation, and flagging for human review.

For advertisement regions, the content processor may apply specialized processing including: advertiser identification through logo recognition or text analysis; ad content categorization (product ads, service ads, political ads, public service announcements); bias detection and transformation capabilities to adjust advertisement content for specific analytical purposes or to create bias-controlled training datasets; and filtering capabilities to exclude advertisements from output artifacts when requested by users.

The synthesis processor 125 receives enriched segmented regions from the content processor 124 and generates output artifacts according to user specifications or predefined templates. An artifact is a structured output derived from one or more content regions, formatted for either human consumption or machine processing. The synthesis processor supports multiple artifact types, each optimized for specific use cases and configured through parameters specifying which content regions to include, how to order or arrange content, what format to use for output, and what annotations or metadata to preserve.

Static webpage artifacts recreate the visual layout of the original webpage while filtering specified content types. For example, to generate an ad-free version of a webpage that preserves the reading experience for human users or accessibility tools, the synthesis processor: identifies all content regions classified as primary content, images, and interactive elements (excluding advertisements and peripheral content); extracts the absolute positioning information for each included region; generates HTML and CSS code that recreates the spatial layout using absolute positioning or CSS grid layouts; embeds extracted text content and images in appropriate HTML elements; and produces a self-contained HTML file that displays the relevant content in its original visual arrangement without requiring external resources or JavaScript execution.

Plain text artifacts extract textual content in reading order for use in downstream text analytics, natural language processing, or machine learning applications. To generate such artifacts, the synthesis processor: identifies all text-containing regions classified as primary content, excluding navigational elements, advertisements, and boilerplate footer text; determines reading order based on positional relationships (top-to-bottom, left-to-right for left-to-right languages, with appropriate adjustments for right-to-left or vertical writing systems); concatenates text content in reading order with appropriate section breaks and formatting markers; and produces output in formats such as plain text, Markdown, or structured JSON with hierarchical organization reflecting the document structure (headings, paragraphs, lists).

Image artifacts compile images extracted from the webpage, optionally filtered by category or annotated with classifications. Applications include creating training datasets for machine learning models, archiving visual content, or extracting product images from e-commerce sites. The synthesis processor may apply transformations to images including: resizing to standard dimensions; format conversion (JPEG to PNG, or vice versa); quality adjustments or compression; watermark addition for attribution; and metadata annotation describing image content, source location on original page, and classification results.

The synthesis processor additionally supports bias transformation and anonymization features for specialized analytical applications. When generating training datasets for machine learning models, the system can apply transformations to eliminate entity-specific biases while preserving content characteristics. For political content analysis, the system can identify political advertisements, candidate names, party affiliations, and geographic references, then replace these with neutral identifiers (e.g., “Candidate A” instead of specific names, “Party 1” instead of party names) while maintaining the argumentative structure, emotional tone, and messaging strategies. This enables training of classification models that learn to recognize persuasion techniques, emotional appeals, and rhetorical patterns independent of specific political entities. Similarly, for competitive intelligence applications, the system can filter or anonymize competitor-specific metadata (company names, product identifiers, proprietary terminology) to enable objective comparative analysis focused on market trends, pricing strategies, and feature sets rather than specific organizational identities.

The synthesis processor stores generated artifacts in artifact storage 122, which may comprise a file system, object storage service, or database. Each artifact is associated with metadata identifying the source webpage, creation timestamp, artifact type and configuration parameters, and quality metrics such as the number of content regions included, confidence scores, and any processing warnings or errors encountered during generation.

The disclosed system enables numerous practical applications across various domains. In content accessibility, the system can transform complex websites into simplified formats optimized for screen readers, braille displays, or users with cognitive disabilities. By extracting primary content and eliminating visual clutter, the system improves accessibility beyond what is achieved by manual HTML accessibility features, particularly for websites with poor accessibility implementation. The system can generate high-contrast versions, linearized reading order formats, or audio-friendly text versions that preserve content structure while removing elements that confuse assistive technologies.

In content moderation and safety applications, the system assists human moderators by automatically detecting and handling potentially harmful content. When processing websites suspected of containing child sexual abuse material (CSAM), violent extremist content, or other harmful material, the system can identify such content through specialized computer vision models (such as those provided by services like Safer.io or proprietary classifiers), automatically blur or pixelate identified images, generate textual descriptions of visual content to enable human review without direct exposure to harmful imagery, and flag affected artifacts with appropriate warnings and metadata. This capability protects the mental health and wellbeing of content moderators, investigators, and analysts who must process large volumes of potentially disturbing material.

In competitive intelligence and market research, the system enables systematic monitoring of competitor websites, product catalogs, pricing information, and promotional content while respecting legal and ethical boundaries. The visual approach maintains functionality even as competitors redesign their websites or implement anti-scraping measures targeting traditional DOM-based scrapers. Organizations can track market trends, monitor product availability, analyze pricing strategies, and gather publicly available information for strategic planning purposes. The system respects robots.txt directives and terms of service restrictions, ensuring legal compliance.

In digital archiving and preservation, the system supports efforts to preserve web content for historical, research, or legal purposes. Unlike traditional web archiving that preserves raw HTML and associated resources, the disclosed system extracts structured content and generates human-readable artifacts that remain accessible even when original websites become unavailable or obsolete technologies (outdated JavaScript frameworks, deprecated browser features, broken external dependencies) render traditional archives non-functional. This approach complements existing web archiving efforts by providing resilient, technology-independent preservation of content.

In news aggregation and content curation, the system extracts article content from diverse news sources regardless of their technical implementation, enabling automated news monitoring, sentiment analysis, topic modeling, and content recommendation systems. The visual approach handles paywalled content (when appropriately licensed), complex layouts, and dynamically loaded content that challenge traditional RSS feeds or HTML scraping.

In machine learning and artificial intelligence research, the system supports creation of training datasets with controlled characteristics. Researchers developing content classification models, sentiment analysis systems, or recommendation algorithms require large, diverse, and appropriately labeled training data. The disclosed system can extract and transform web content while applying bias controls to create balanced training sets. For example, when training political content classifiers, the system can transform candidate names, party affiliations, or geographic references to create datasets that train models on content characteristics rather than specific political entities. Similarly, the system can filter competitor-specific information to enable unbiased comparative analysis across multiple organizations without metadata that could introduce analytical bias.

In security and law enforcement applications, the system can be configured to process websites identified by Deep Traveler data providers as containing potential information about one or more subjects undergoing screening or investigation as part of civil aviation security or border security processing. Deep Traveler provides intelligence data to security and law enforcement authorities, and the disclosed visual analysis system enables efficient processing of identified websites regardless of their technical implementation or anti-scraping measures. The system's ability to extract relevant content while handling potentially sensitive or inappropriate material (through automated content detection and transformation) makes it particularly suitable for investigative workflows where human analysts must review large volumes of potentially disturbing content. The visual approach maintains functionality even when subjects use websites with deliberately obfuscated code structures or frequently changing layouts designed to impede automated analysis.

The disclosed system is designed to operate within legal and ethical boundaries governing automated website access and data collection. The system respects robots.txt directives by checking for and honoring disallow rules, crawl delays, and other robot exclusion protocol directives before initiating requests. The request engine examines robots.txt files and refrains from accessing prohibited paths or violating specified access restrictions. Users of the system bear responsibility for ensuring their usage complies with applicable laws, website terms of service agreements, and data protection regulations including the General Data Protection Regulation (GDPR), California Consumer Privacy Act (CCPA), and similar frameworks governing personal data processing.

Request pseudonymization features are designed to distribute access load across network endpoints to avoid server overload and maintain access diversity, not to circumvent access controls or evade detection for unauthorized purposes. The system supports rate limiting to ensure requests do not overwhelm target servers, respects HTTP response codes indicating service unavailability or access restrictions, and implements exponential backoff when encountering errors or rate limit signals. Users must obtain appropriate authorization before accessing non-public content and must respect intellectual property rights, copyright protections, and contractual obligations when processing website content.

The system's ability to process and transform website content does not grant users rights to republish, redistribute, or commercially exploit copyrighted material without appropriate licenses or fair use justification. Generated artifacts may be used for purposes including accessibility enhancement, archival preservation, research and analysis, content moderation, and other applications consistent with applicable law and licensing agreements. Users should consult legal counsel when questions arise regarding the lawfulness or appropriateness of specific use cases.

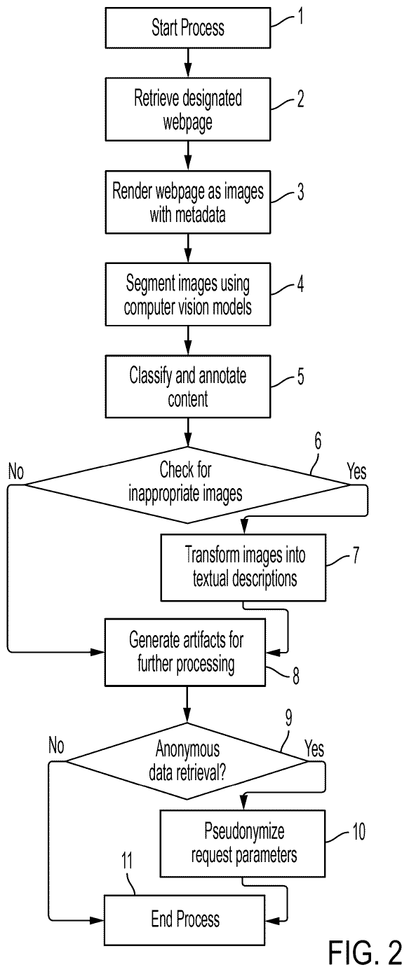

FIG. 2 illustrates a flowchart for the method utilized by the system architecture depicted in FIG. 1 according to an example embodiment. The process begins at step 1 with initiation of the extraction and analysis workflow. At step 2, the system retrieves a designated webpage by accessing the targeting system to obtain request parameters, submitting the request through the request pseudonymizer to apply any configured transformations, and executing the request via headless browsers to render the complete webpage including dynamically loaded content.

At step 3, the system renders the webpage as one or more images with associated metadata. This involves capturing screenshots of the rendered webpage at various scroll positions or viewport configurations to ensure complete coverage of content extending beyond a single screen, extracting metadata including page dimensions, loaded resources, execution timing, and any console errors or warnings, and storing the images and metadata in appropriate storage systems for subsequent processing.

At step 4, the system segments the images using computer vision models trained specifically for webpage layout analysis. The segmentation processor applies convolutional neural network models to identify visually distinct regions, generates bounding boxes and classification labels for each identified region, extracts visual features and positional information, and preserves the original layout context to enable reconstruction when needed.

At step 5, the system classifies and annotates content within each segmented region. The content processor applies optical character recognition to extract text from text-containing regions, performs image analysis on image-containing regions, applies natural language processing to extracted text for semantic classification and entity recognition, and generates confidence scores and quality metrics for each processed element.

At step 6, the system checks for inappropriate images that require special handling. This decision point evaluates whether any segmented regions contain content classified as potentially harmful, illegal, or sensitive (such as violence, explicit content, CSAM, or other categories specified in system configuration). If inappropriate content is detected, the process proceeds to step 7; otherwise, it continues to step 8.

At step 7 (conditional, executed only when inappropriate content is detected), the system transforms images into textual descriptions. This transformation protects human reviewers from direct exposure to harmful content while preserving the analytical value of the information. The system applies image captioning models or scene description generators to create textual summaries of visual content, replaces original images with blurred versions or placeholder graphics, annotates the textual descriptions with classification labels and confidence scores, and marks the affected artifacts with appropriate content warnings.

At step 8, the system generates artifacts for further processing. The synthesis processor assembles processed content elements according to user-specified configurations or predefined templates, produces output in requested formats (static HTML, plain text, JSON, image collections), applies any final transformations or filtering, and stores completed artifacts in the artifact storage with associated metadata and quality metrics.

At step 9, the system checks whether anonymous data retrieval is required. This decision point determines whether request pseudonymization or data anonymization features should be applied based on policy configuration, content sensitivity, user preferences, or regulatory requirements. If anonymization is required, the process proceeds to step 10; otherwise, it continues to step 11.

At step 10 (conditional, executed when anonymization is required), the system parses and optimizes request parameters to enhance privacy protection or analytical objectivity. This may involve redacting personally identifiable information from request payloads, replacing authentication credentials with anonymized tokens, adjusting request timing and patterns to prevent correlation with specific users, or applying bias transformation to content (such as replacing political candidate names with generic placeholders in advertisement analysis) to create unbiased training datasets for machine learning applications.

At step 11, the process concludes. The system may trigger notifications to users or downstream systems that new artifacts are available, update status dashboards or monitoring systems, schedule follow-up requests if configured for periodic monitoring, or initiate additional processing workflows such as text analytics, machine learning model training, or content distribution.

Although not explicitly shown in the figures, the system architecture may include or utilize various computing components. A communication bus or other communication mechanism is configured to communicate information between system components, including the processor, memory, storage devices, and external interfaces. The bus may comprise a system bus, a peripheral component interconnect (PCI) bus, a PCI Express bus, or any other suitable bus architecture for facilitating data transfer between components.

A communication device enables connectivity between processors and other system components, as well as external network connections. The communication device may include a network interface card configured to provide wired network communications (Ethernet, fiber optic) or wireless network communications (Wi-Fi, cellular, satellite). The communication device encodes data for transmission over networks and decodes data received from external systems. Various wireless communication techniques may be employed including infrared, radio frequency, Bluetooth, Wi-Fi, cellular protocols (4G/5G), or other suitable wireless communication methods.

The processor may comprise one or more general-purpose processors (such as x86 or ARM processors) or specialized processors optimized for specific tasks (such as graphics processing units for accelerating computer vision operations, tensor processing units for neural network inference, or field-programmable gate arrays configured for image processing pipelines) to perform computation and control functions of the system. The processor may include a single integrated circuit or multiple integrated circuit devices and circuit boards working in cooperation to accomplish system functions. The processor executes software instructions to implement the request engine, analysis engine, segmentation processor, content processor, and synthesis processor described herein.

The system includes memory for storing information and instructions for execution by the processor. Memory may contain various components for retrieving, presenting, modifying, and storing data. Memory stores software modules that provide functionality when executed by the processor, including an operating system that provides operating system functionality, driver software for hardware components, and application software implementing the disclosed web analysis functions. Memory may include any combination of random access memory (RAM), dynamic RAM (DRAM), static RAM (SRAM), read-only memory (ROM), flash memory, cache memory, or any other type of volatile or non-volatile computer-readable medium.

Database storage provides centralized or distributed storage for system data. The database stores data in integrated collections of logically-related records or files. The database may be implemented as an operational database, analytical database, data warehouse, distributed database, in-memory database, document-oriented database, relational database, object-oriented database, graph database, time-series database, or any other database type suitable for the specific data storage requirements. The image store, metadata store, and artifact storage described herein may be implemented using database storage, file systems, object storage services, or combinations thereof.

Although illustrated as a single system, the functionality may be implemented as a distributed system across multiple computing devices. The system may be deployed in cloud computing environments using virtual machines, containers, or serverless computing platforms. Components may be scaled independently based on workload characteristics—for example, deploying multiple parallel instances of segmentation processors to handle high volumes of webpage processing, or distributing storage across geographically diverse data centers for redundancy and performance. Further, one or more components described herein may be omitted or reconfigured depending on specific deployment requirements and use cases.

The system demonstrates improved performance characteristics compared to traditional DOM-based web scraping approaches. In empirical testing across diverse website types, the visual analysis approach maintained consistent extraction accuracy despite website redesigns that would have required manual reconfiguration of traditional scrapers. Processing time per webpage varies based on factors including page complexity, image resolution, viewport configuration, and hardware capabilities, but typically ranges from 2-10 seconds per page on modern server hardware equipped with GPU acceleration for computer vision operations. This performance enables practical deployment for applications requiring processing of hundreds to thousands of webpages per hour.

The system's resilience to website changes represents a significant advantage over code-based approaches. When target websites undergo structural redesigns involving changes to HTML element identifiers, class names, or DOM structure, traditional scrapers fail immediately and require manual intervention to update selectors and navigation logic. In contrast, the visual approach continues functioning provided the visual presentation of content remains interpretable—content areas remain visually distinct, text remains readable, and layout follows recognizable design patterns.

Accordingly, the present disclosure provides systems, devices, methods, and computer-readable instructions for analyzing website content through computer vision and natural language processing. The disclosed technology extracts and transforms web-based data by processing rendered webpages as visual documents, facilitating automated analysis and human consumption while reducing dependency on website-specific structural knowledge and maintaining robust functionality despite changes in underlying website technologies and implementations.

It will be apparent to those skilled in the art that various modifications and variations can be made in the systems, devices, methods, and instructions for web content transformation using computer vision and natural language processing of the present invention without departing from the spirit or scope of the invention. Thus, it is intended that the present invention cover the modifications and variations of this invention provided they come within the scope of the appended claims and their equivalents.

What is claimed is:

1. A method for extracting structured content from webpages using computer vision, comprising:
retrieving a target webpage from a network location;
rendering the target webpage in a browser environment to generate one or more rendered images representing a visual appearance of the webpage;
processing the one or more rendered images using a computer vision model trained on webpage layout patterns to identify and segment distinct visual regions corresponding to webpage elements;
classifying the segmented visual regions into content categories including at least primary content, navigational elements, and supplementary content based on visual features extracted by the computer vision model;
extracting data from the classified visual regions using optical character recognition and image processing techniques; and
synthesizing the extracted data into a structured output format independent of the target webpage's underlying markup language, wherein the structured output maintains extraction consistency when the target webpage's markup structure changes while visual presentation remains substantially similar.

2. The method of claim 1, wherein the computer vision model comprises a convolutional neural network with region proposal layers configured to generate candidate bounding boxes at aspect ratios and scales optimized for webpage element types.

3. The method of claim 2, wherein processing the one or more rendered images further comprises:
applying the convolutional neural network trained on a dataset of annotated webpage screenshots representing diverse design styles, technical implementations, and content types;
generating segmentation masks identifying pixel-level boundaries of content regions; and
associating each segmented region with confidence scores indicating model certainty in classification.

4. The method of claim 1, wherein classifying the segmented visual regions comprises:
analyzing spatial positioning of regions relative to webpage boundaries;
evaluating color contrast between regions and surrounding content;
assessing typographic characteristics including font sizes, styles, and text density; and
determining hierarchical relationships between regions based on visual containment and proximity.

5. The method of claim 1, further comprising:
applying natural language processing to text extracted from the classified visual regions to determine semantic relevance;
filtering regions classified as advertisements, navigation elements, or boilerplate content based on the semantic relevance determination; and
prioritizing regions classified as primary content in the structured output format.

6. The method of claim 1, wherein synthesizing the extracted data comprises:
generating a static webpage artifact that recreates visual layout of the target webpage using absolute positioning or cascading style sheet grid layouts while excluding advertisement regions; or
generating a plain text artifact that concatenates text content from primary content regions in reading order determined by positional relationships.

7. The method of claim 1, further comprising:
detecting inappropriate visual content in image-containing regions using a specialized classifier trained to identify categories selected from violence, explicit content, and child sexual abuse material;
upon detection of inappropriate visual content, generating a textual description of the inappropriate visual content using an image captioning model;
replacing the inappropriate visual content with the textual description in the structured output format; and
annotating the structured output format with a content warning indicator.

8. The method of claim 1, further comprising:
pseudonymizing request parameters prior to retrieving the target webpage, wherein pseudonymizing comprises modifying at least one of: IP address through proxy rotation, user agent string, referrer information, or request timing patterns to distribute access load.

9. The method of claim 1, wherein the computer vision model is continuously improved through:
identifying segmented regions with confidence scores below a predetermined threshold;
queuing the identified segmented regions for human annotation;
incorporating human-annotated regions into a training dataset; and
retraining or fine-tuning the computer vision model using the updated training dataset.

10. A system for analyzing webpage content through visual interpretation, comprising:
a processor;
a memory coupled to the processor;
a rendering engine configured to execute on the processor and generate visual representations of webpages by rendering retrieved webpages in a browser environment;
a segmentation module configured to apply a computer vision model to the visual representations to identify distinct content regions;
a classification module configured to categorize the identified content regions based on visual characteristics, spatial positioning, and semantic analysis of extracted text; and
a synthesis module configured to generate structured output artifacts from the categorized content regions in formats selected from static webpages, plain text documents, and annotated image collections.

11. The system of claim 10, wherein the computer vision model comprises a region-based convolutional neural network with feature extraction layers tuned to detect webpage-specific visual patterns including text blocks, navigation elements, and advertisement regions.

12. The system of claim 10, wherein the segmentation module is further configured to:
preserve absolute pixel coordinates for each identified content region;
extract visual features from each region including dominant colors, text density, and presence of interactive elements; and
determine hierarchical parent-child relationships between content regions based on visual containment.

13. The system of claim 10, wherein the classification module employs:
optical character recognition to extract text from text-containing regions while preserving font characteristics;
language identification to determine character sets and languages using statistical analysis;
named entity recognition to identify persons, organizations, locations, and dates within extracted text; and
image classification to categorize image-containing regions as photographs, diagrams, icons, or logos.

14. The system of claim 10, further comprising:
a request pseudonymizer configured to modify request parameters including IP addresses, HTTP headers, and request timing to distribute access load; and
a web driver configured to interact with headless browsers for executing webpage requests and capturing rendered output with associated metadata.

15. The system of claim 10, wherein the synthesis module is configured to:
generate static webpage artifacts that recreate original layout using absolute positioning while filtering advertisement content; or
generate plain text artifacts ordered by reading sequence determined from positional relationships of content regions.

16. The system of claim 10, further comprising an inappropriate content detection module configured to:
apply specialized computer vision models to identify harmful visual content;
generate textual descriptions of identified harmful content using scene analysis techniques; and
replace harmful content with textual descriptions in generated artifacts.

17. The system of claim 10, wherein the computer vision model is trained using:
a training dataset comprising webpage screenshots annotated with segmentation masks and content category labels;
data augmentation techniques including viewport size variation, color adjustments, and synthetic occlusions; and
loss functions weighted to prioritize accurate identification of primary content regions.

18. A non-transitory computer-readable medium storing instructions for performing webpage analysis using computer vision, the instructions when executed by a processor causing the processor to:
retrieve a target webpage and render the target webpage to generate rendered images with supporting metadata;
segment the rendered images into visually distinct elements using a convolutional neural network trained on webpage layout patterns, wherein the convolutional neural network includes region proposal layers configured for webpage element detection;
process the segmented elements for content classification and extraction using optical character recognition and image analysis;
classify extracted content based on visual features and semantic analysis to distinguish primary content from peripheral elements; and
synthesize the classified content into output artifacts configured for human consumption or machine processing.

19. The computer-readable medium of claim 18, wherein the instructions further cause the processor to:
respect robot exclusion protocol directives by examining robots.txt files before initiating requests;
implement rate limiting to avoid overwhelming target servers; and
apply exponential backoff when encountering HTTP error responses or rate limit signals.

20. The computer-readable medium of claim 18, wherein synthesizing the classified content comprises:
generating ad-free static webpages with preserved original layout for accessibility enhancement;
generating linearized text output with maintained reading order for text analytics processing; or
generating annotated image datasets with classification labels for machine learning training.

21. The computer-readable medium of claim 18, wherein the instructions further cause the processor to:
continuously improve the convolutional neural network by identifying low-confidence classifications;
queuing low-confidence examples for human review and annotation;
incorporating annotated examples into the training dataset; and
performing incremental retraining to adapt to emerging webpage design trends.

22. The computer-readable medium of claim 18, wherein processing the segmented elements comprises:
applying language identification to determine character sets and languages of text content;
extracting text using optical character recognition while preserving formatting information;
performing named entity recognition on extracted text to identify specific entities; and
classifying images using specialized models trained to detect inappropriate content categories.

23. A method for training a computer vision model for webpage content extraction, comprising:
collecting a training dataset comprising webpage screenshots captured across diverse website types, design styles, and technical implementations;
annotating the webpage screenshots with pixel-level segmentation masks identifying boundaries of content regions and category labels selected from header, navigation, primary content, sidebar, advertisement, and footer;
training a region-based convolutional neural network on the annotated webpage screenshots to recognize visual patterns indicative of the category labels, wherein training comprises optimizing network parameters using loss functions weighted to prioritize accurate identification of primary content regions;
validating the trained network against webpage layouts from different industries, design eras, and cultural contexts; and
deploying the validated network for processing webpages to extract structured content independent of underlying markup languages.

24. The method of claim 23, wherein collecting the training dataset comprises:
capturing screenshots at multiple viewport dimensions to represent diverse device types;
including webpages implementing different technical frameworks selected from static HTML, JavaScript-based single-page applications, and server-rendered multi-page applications;
representing multiple languages, writing directions, and design aesthetics; and
spanning multiple time periods to capture evolution of web design conventions.

25. The method of claim 23, wherein training the region-based convolutional neural network comprises:
configuring region proposal layers to generate bounding boxes at aspect ratios and scales characteristic of webpage elements;
tuning feature extraction layers to detect webpage-specific patterns including typography, button styles, and layout grids; and
applying data augmentation including viewport size variation, color scheme adjustments, and synthetic occlusion introduction.

26. The method of claim 23, further comprising:
implementing active learning by identifying predictions with low confidence scores during deployment;
obtaining human annotations for low-confidence predictions;
augmenting the training dataset with human-annotated examples; and
performing incremental retraining to improve model performance on previously challenging cases.
